(19) United States
(12) Patent Application Publication
(10) Pub. No.: US 2013/0141763 A1
(43) Pub. Date: Jun. 6, 2013

(54) Method and System for Optimal Die-Cutting

(71) Applicants: Fabio Giannetti, Los Gatos, CA (US); Kok-Wei Koh, Mountain View, CA (US); Jose Manuel Perez, Mountain View, CA (US); Benjamin I. Dempster, San Francisco, CA (US); Alysha Naples, Oakland, CA (US)

(72) Inventors: Fabio Giannetti, Los Gatos, CA (US); Kok-Wei Koh, Mountain View, CA (US); Jose Manuel Perez, Mountain View, CA (US); Benjamin I. Dempster, San Francisco, CA (US); Alysha Naples, Oakland, CA (US)

(21) Appl. No.: 13/699,776

(22) PCT Filed: Jun. 11, 2010
(86) PCT No.: PCT/US10/38397

§ 371 Date: Nov. 26, 2012

(51) Int. Cl. G06K 15/02

(52) U.S. Cl. CPC G06K 15/021
USPC 358/1.18

(57) ABSTRACT

The present disclosure provides methods and systems for ganging print jobs (102-112) that use different dies. An exemplary embodiment provides a non-transitory, computer-readable medium that includes code configured to direct a processor to identify individual label printing jobs (102-112) that are similar, but use different dies. A combined, or ganged, print job (506) is then formed from the individual label printing jobs (102-112), wherein the ganged print job (506) uses a multi-format die (300).

### BACKGROUND

The production of packaging and container labels typically consists of printing on a flexographic or digital press, followed by a finishing process that may include foil stamping, lamination, and die cutting. Print service providers (PSPs) manage a collection of dies that support common label sizes. If a new order involves a label size that is not supported by the PSP's current set of dies, a custom the will have to be made, which adds a significant cost for the customer. Another PSP may have the necessary the for a particular label order, but it is difficult for a customer to discover that PSP unless they do an exhaustive search of all possible PSPs. In addition, labels of different sizes are usually processed separately, which could lead to unnecessary paper waste. For example, if a particular label has a height that is slightly more than 50% of the roll width, it can only be printed one across. The remaining width of the roll is not used and, thus, will be wasted unless a narrower roll is used, which would add a significant amount of “down” time and labor costs to the operation.

### BRIEF DESCRIPTION OF THE DRAWINGS

Certain exemplary embodiments are described in the following detailed description and in reference to the drawings, in which:

FIG. 1 is a drawing of six label orders that may be ganged in accordance with exemplary embodiments of the present invention;

FIG. 2 is a top view of a label substrate, showing the ganging of jobs on the label substrate, in accordance with exemplary embodiments of the present invention;

FIG. 3 is a drawing of a custom multi-format die for the ganged jobs shown in FIG. 2, in accordance with exemplary embodiments of the present invention;

FIG. 4 is a process flow diagram showing a method for ganging jobs, in accordance with exemplary embodiments of the present techniques;

FIG. 5 is a block diagram showing an example of the use of the method of FIG. 4 to combine print jobs, in accordance with exemplary embodiments of the present invention;

FIG. 6 is a block diagram of a system that may be used to implement the ganging of label jobs, in accordance with an exemplary embodiment of the present techniques; and

FIG. 7 is a block diagram of a non-transitory, computer-readable medium that may store code modules that implement exemplary embodiments of the present invention.

### DETAILED DESCRIPTION OF SPECIFIC EMBODIMENTS

Currently, there is no mechanism or process for customers or print service providers (PSPs) to coordinate across a large number of orders to determine an optimal way to combine orders of similar length on printing rolls, and then coordinate the purchase of a “multi-order format” die that can benefit all parties. Further, a chosen PSP might be located far from the destination shipping location of the customers of the combined orders, which could lead to higher shipping costs and longer shipping times.

The current practice is to gang, or group, jobs that have a matching die and substrate, e.g., paper. If different label jobs require different dies these are imposed, i.e., arranged on a substrate surface, separately. Only jobs with the same size and die cutting requirement can be imposed as a single job. This limits the possible combinations and does not resolve the case where labels have a size that is more than 50% of the roll width. In this case, existing solutions can only impose a single label in the roll width, resulting in a significant amount of wasted substrate.

Exemplary embodiments of the present invention provide a method and a system of ganging and routing label orders with similar substrates to the PSP within a network that is best equipped to fulfill that particular job. A database of available “multi-format” dies within the PSP network can be maintained to ensure the optimal routing of jobs and avoid the unnecessary creation of duplicate dies. Label imposition will combine orders with similar linear footage in order to minimize the waste of substrate. Custom multi-format dies are created as efficiently as possible, taking into account all outstanding orders in order to maximize the utility of producing a new die layout and sharing the cost of the die among compatible orders. Once a new multi-format die is produced, it can be added to the database of available multi-format dies and re-used for future jobs with similar optimized imposition patterns at no extra cost. Finally, the locations of the PSPs are taken into consideration to minimize shipping costs and shipping times for ganged orders.

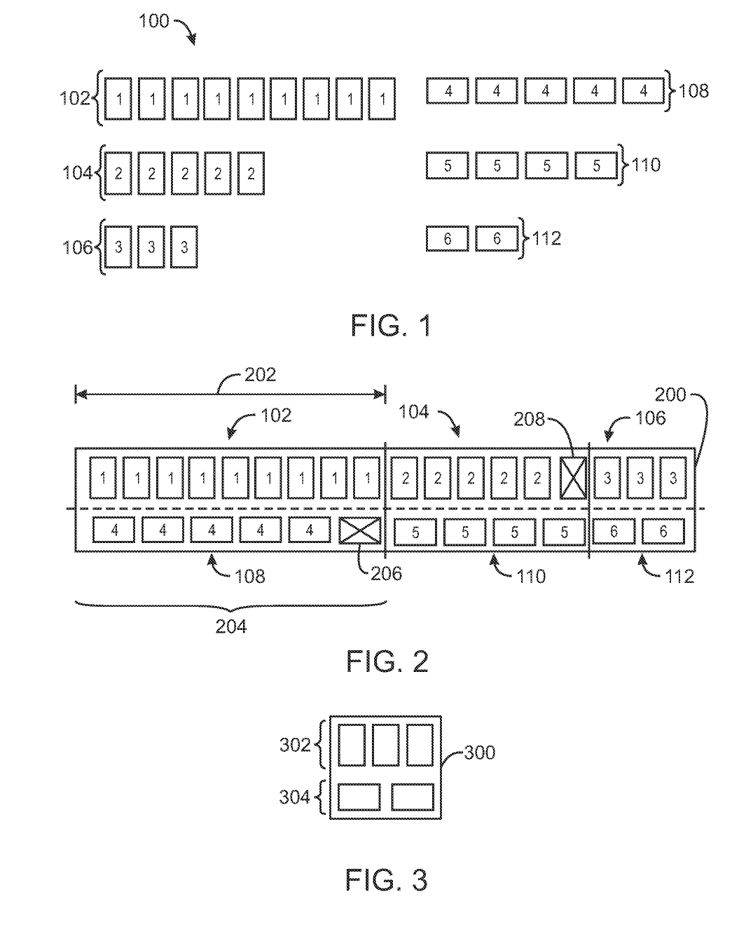

FIG. 1 is a drawing of six label orders 100 that may be ganged in accordance with exemplary embodiments of the present invention. The six orders 100, labeled as 102-112, may come from individual customers, or may be different orders from a single customer. Further, the orders 102-112 may have different rewind standard requirements along a roll as well as different lengths. It can be assumed for purposes of this example that all six orders are to be printed on the same substrate.

Generally, orders 102-106 will use a first die, while orders 108-112 will use a second die. Due to the differences in dies, past ordering systems would not have allowed for combining any of orders 102-106 with orders 108-112. Further, the labels for orders 102-106 may cause a significant amount of waste. For example, if a label in orders 102-106 is larger than 50% of the width of a roll of substrate material, it can only be imposed 1-up, i.e., one label on each section of the roll. This wastes an amount of substrate directly proportional to the formula: (roll width-label height) * linear footage. As discussed herein, an exemplary embodiment of the present invention gangs label jobs into a single roll of substrate using a die cut management system.

FIG. 2 is a top view of a label substrate 200, showing the ganging of jobs on the label substrate 200, in accordance with exemplary embodiments of the present invention. For example, the system described herein may match job candidates based on the substrate 200, the linear footage 202 to be printed, shipping information, and die cut requirements. The linear footage 202 is defined as the label width and the spacing between labels multiplied by the number of labels in the order. Accordingly, jobs that are similar in length, such as orders 102 and 108 in this example, may be combined into a ganged print job 204. A blank label 206 may be inserted to match the length of the individual print jobs, so that both end at the same point. Similarly, orders 104 and 110 may be ganged on the substrate 200, with another blank label 208 inserted to match the lengths. In some cases, the lengths of the jobs may end at the same points, as shown for orders 106 and 112 in the example of FIG. 2. The main advantages of ganging the jobs are a reduction of wasted substrate 200, higher productivity due to a higher concentration of labels per linear foot, greater utilization of press time due to less set-up downtime, and reduced operator intervention.

FIG. 3 is a drawing of a custom multi-format die 300 for the ganged jobs shown in FIG. 2, in accordance with exemplary embodiments of the present invention. In the exemplary embodiment shown in FIG. 3, a first area 302 of the multi-format die 300 may be designed, for example, to cut labels resembling orders 102-106 of FIG. 1, while a second portion of the die may be designed, for example, to cut labels resembling order 108-112. While existing solutions only consider compatibility with existing dies at a single PSP, the method described herein considers the creation of a custom multi-format die 300 for the ganged job 204 from multiple sources. Further, the method considers custom multi-format dies 300, previously created.

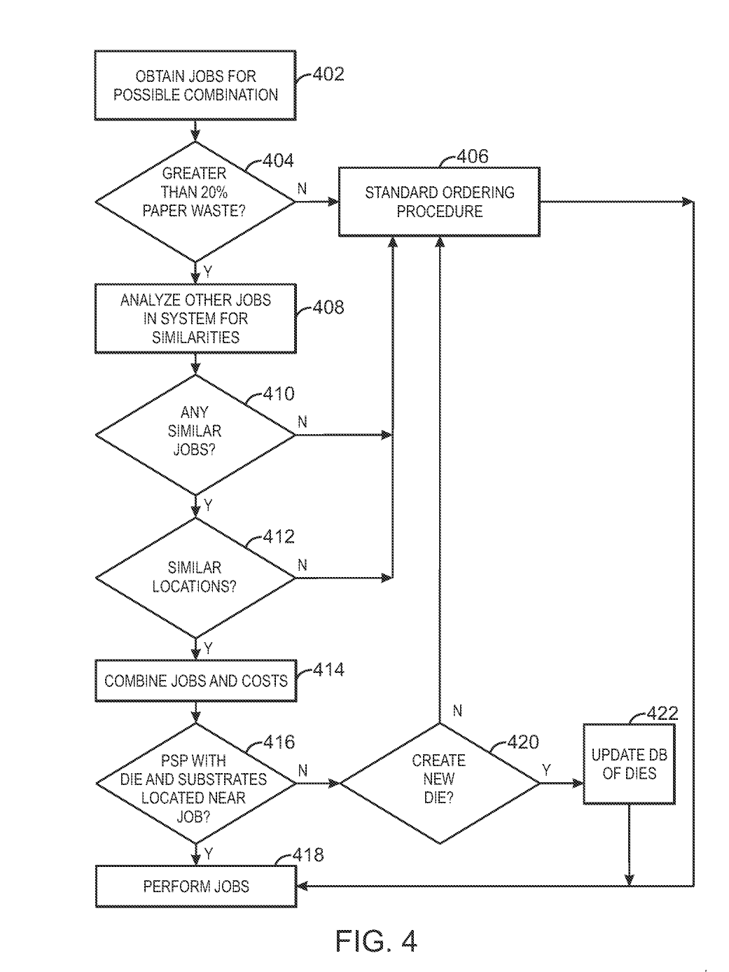

If multi-format dies 300 are seen as a global resource among different PSPs, the availability of a particular multi-format die 300 within the PSP network can influence the ganging and routing of jobs. As a result, existing multi-format dies 300 will be better utilized, lowering the production costs, the shipping costs, and the carbon footprint of the process. Further, having global knowledge of all incoming orders and available dies within the PSP network also enables the ganging of jobs that have compatible shipping requirements. This can be based on the destination address, shipping costs, shipping time, and other requirements. The ganging of jobs is discussed with respect to FIG. 4.

FIG. 4 is a process flow diagram showing a method 400 for ganging jobs, in accordance with exemplary embodiments of the present techniques. The method 400 begins at block 402 with the system obtaining individual label printing jobs. The entry of the jobs may take place at one point, for example, into a server on the Internet that can be configured to analyze the orders and send the orders to the appropriate PSPs. In other embodiments, the entry may be performed at individual servers, and the analysis of the jobs may be performed through the central server. At block 404, a job may be evaluated to determine the amount of substrate wasted by the job. If the amount of wasted substrate is less than a selected threshold, for example, 20% of the width, the process flow may proceed to block 406, where a standard ordering procedure may be used. Form block 406, process flow proceeds to block 418, at which the printing jobs are executed. However, if the amount of wasted substrate is equal to or greater than the threshold, process flow may proceed to block 408.

At block 408, other jobs in the system are analyzed to determine if other jobs are similar jobs and can be ganged. Similarity may be determined by the substrate requested, the location of the jobs, the linear footage of the jobs after the imposition, the similarities in printing, and the like. For example, if jobs have a similar length, they can be ganged to reduce the waste while still enabling a clear cut (guillotine style) between jobs. At block 410, if no similar jobs are identified, process flow may return to block 406, at which the standard ordering procedure may be used. If similar jobs are identified at block 410, process flow may proceed to block 412, where a determination is made as to the proximity of the jobs. If the jobs are not in a similar location, for example, located in the same region of a country, process flow may proceed to block 406, and the standard ordering procedure may be used. This determination enables the final ganged print job to be routed to a PSP that is close to the delivery points, reducing the shipping costs.

If the jobs are identified as being in similar locations at block 412, process flow proceeds to block 414, at which the jobs and costs are combined. The method 400 will combine jobs so long as buyers of the ganged job are not paying more because of the job merging. Generally, the lowest cost option would occur if a multi-format die already exists at a PSP proximate to the buyers.

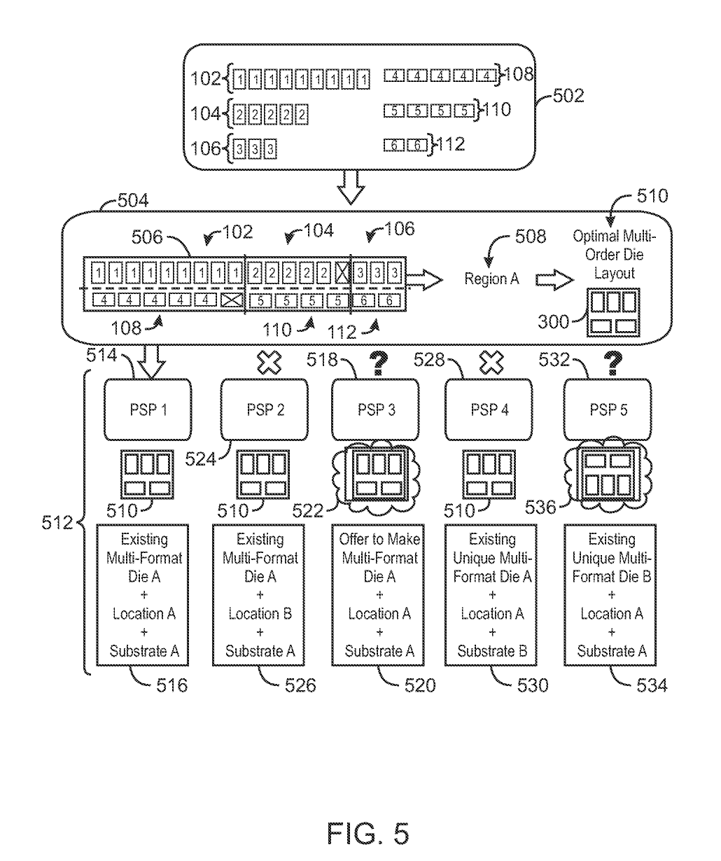

At block 416, a determination is made as to whether a multi-format the exists and an appropriate substrate for the ganged job exists at a PSP located near the ganged job. If so, the order may be placed with that PSP, and the job may be performed as indicated at block 418. If not, process flow proceeds to block 420 to determine if it is economical to have a new multi-format die made (or to ship the appropriate substrate). For example, the cost of the new multi-format die can be shared among two or more jobs with different packaging geometries (1″×3″ label plus 3″×2″ label) and can be offset by the reduction in costs achieved by lowering the amount of wasted substrate. Once it is determined to be economically viable to produce a new multi-format die, the multi-format die is built and added to the database of available multi-format dies, as indicated at block 422. Process flow may then proceed to block 418 for execution of the job. The method 400 may be more clearly explained by the example shown in FIG. 5.

FIG. 5 is a block diagram showing an example of the use of the method of FIG. 4 to combine print jobs, in accordance with exemplary embodiments of the present invention. The example is based on orders 102-112 shown in FIGS. 1 and 2, as illustrated at block 502. The labels in orders 102-106 may take more than 50% of a substrate width, leading to a substantial amount of wasted substrate.

As indicated at block 504, the orders 102-112 may be analyzed for similarities, as discussed with respect to block 408 of FIG. 4. The analysis of orders 102-112 may indicate that all of the orders 102-112 use the same substrate and are close in length, allowing their combination on a single ganged print job 506, as discussed with respect to block 410. Further, as discussed with respect to block 412, it may be determined in this example that all of the orders 102-112 are located near each other, for example, in Region A 508.

Thus, as discussed with respect to block 414, the jobs and costs may be combined. A first determination to be made, as discussed with respect to block 416, is whether a multi-format die 300 exists with the correct layout 510 for the ganged print job 506. This may then lead to a decision tree for determining appropriate PSPs, as indicated at the bottom 512 of FIG. 5. Each of the possible PSPs can then be compared to the location, substrate, and multi-format the needs of the ganged print job to determine which, if any, of the PSPs may be capable of performing the job.

For example, PSP 1 514 may have the appropriate multi-format die 300, be in the proper location, and have the substrate required, as indicated at block 516. Thus, PSP 1 514 may be an appropriate choice for the ganged print job 506, as indicated by the arrow. However, PSP 3 518 may also be in the correct location and have the correct substrate, as indicated at block 520. Although PSP 3 518 may not have the multi-format die, it may make an offer 522 to build the multi-format die 300. Thus, PSP 3 518 may be a possible choice for the ganged print job, as indicated by the question mark. The costs of building the multi-format die may be distributed among the orders 102-112. However, PSP 3 520 may offer to build the multi-format die 300 at no cost to be able to compete with PSP 1 514. Thus, some feedback from the ordering system to the various PSP may be included to facilitate competition and lower costs for buyers.

Other PSPs may be eliminated from consideration as indicated by an “x” in the block diagram. For example, PSP 2 524 may have the multi-format die 300 and the substrate, but may not be located in the correct region, as indicated at block 526. Similarly, PSP 4 528 may have the multi-format die 300 and be in the correct location, but may not have access to the substrate, as indicated at block 530.

Finally, PSP 5 532 may have the substrate and be located in the correct region 534, but not have the correct multi-format die 300. However, PSP 5 532 may have a multi-format die 536 that is capable of cutting similar shapes. If this multi-format die 536 may be used for the job, the decision may be based on the PSP that gives the lowest cost to the buyers of orders 102-112, In other words, the choice may be invisible to the buyers.

As can be seen with respect to PSP 3 518, the management of the special multi-formal dies that can produce different geometries will expand over time, especially as PSPs compete to get jobs. In the long term, multi-format dies may be created that cover all the possible combinations. When this stage is reached, jobs will be more easily ganged as there will not be extra costs from creating new multi-format dies.

The orders 102-112 and multi-format dies 300, 536 discussed herein are merely exemplary. In embodiments, the orders may have any lengths and use dies of any arrangements, including dies having three, four, or more rows of labels.

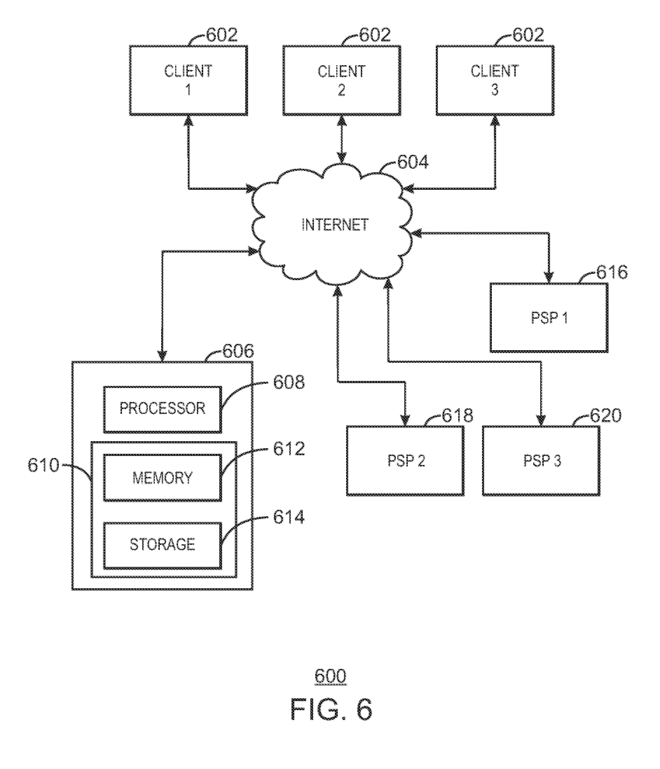

FIG. 6 is a block diagram of a system 600 that may be used to implement the ganging of label printing jobs, in accordance with an exemplary embodiment of the present techniques. In the system 600, a number of client systems 602 may be used by buyers to order labels over the Internet 604. However, the access is not limited to the Internet 604, as any networking technology may be used in embodiments, including local area networks (LANs), wide area networks (WANs), and the like. The client systems 602 may be used to access a print ordering system 606 to place an order for labels.

The print ordering system 606 may include a processor 608 and non-transitory, computer-readable storage media 610, such as a memory 612 and a storage system 614. The processor 608 may be a single processor or a cluster computing system. The memory 612 may include random access memory (RAM) and read-only memory (ROM). The storage system 614 may include hard drives, optical drives, RAM disks, or any number of other storage units.

The non-transitory computer-readable storage media 610 may include software configured to obtain label orders from the client systems 602 and place labels orders with print service providers (PSPs), such as PSP 1 616, PSP 2 618, and PSP 3 620.

The non-transitory computer-readable storage media 610 may also hold a database of PSPs and multi-format dies. The database may hold information needed for determining appropriate vendors for particular labels. For example, the database may contain substrates, multi-format dies, locations, and other information obtained from the first supplier 606, a second supplier 620, or any number of other suppliers. However, the database does not need to contain all of the information needed to analyze the PSPs, or even all of the possible PSPs that may be used. In embodiments, the database may access external databases to discover PSPs.

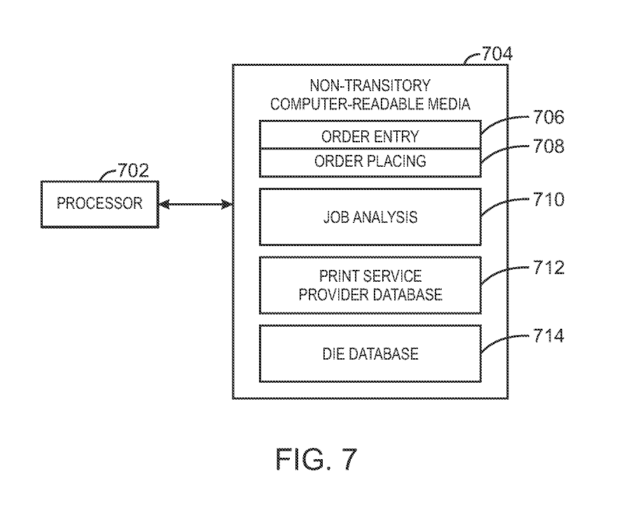

FIG. 7 is a block diagram of a non-transitory, computer-readable medium that may store code modules that implement exemplary embodiments of the present invention. As shown in FIG. 7, a processor 702 may access the modules stored in the non-transitory, computer-readable medium 704. The non-transitory, computer-readable medium may include various types of storage units, such as a memory or storage system. The modules may include an order entry system 706, for example, accessible to a buyer over the Internet. The modules may also include an order placement system 708 for forwarding orders to appropriate PSPs after order analysis is complete. A job analysis module 710 may analyze jobs to determine similarities, as discussed with respect to the method 400 of FIG. 4. A PSP database 712 may include information on PSPs, such as location, available multi-format dies, and available substrates. The PSP database may be used by the job analysis module 710 to determine where combined orders can be placed. Further, a database 714 can contain a list of all available multi-format dies. The code is not limited to the modules shown in FIG. 7, but may use any arrangement or configuration of code to achieve the same functionality.

What is claimed is:

1. A print ordering system (606) for ganging individual label printing jobs (102-112), comprising:
a processor (608); and
a memory (612), wherein the memory (612) comprises code configured to direct the processor (608) to:
identify (408) individual label printing jobs (102-112) that are similar, wherein the individual label printing jobs (102-112) use different dies; and
form (414) a ganged print job (204, 506) from the individual label printing jobs (102-112), wherein the ganged print job (204, 506) uses a multi-format die (300).

2. The print ordering system (606) of claim 1, comprising a storage system (614) that comprises a database (712) of PSPs (616, 618, 620).

3. The print ordering system (606) of claim 1, comprising a storage system (614) that comprises a database (714) of existing multi-format dies (300).

4. The print ordering system (606) of claim 1, wherein the memory (612) comprises code configured to direct the processor (608) to locate (416) a print service provider (PSP) (616, 618, 620) that can perform the ganged print job (204, 506).

5. The print ordering system (606) of claim 4, wherein the memory (612) comprises code configured to direct the processor (608) to determine (416) whether a candidate PSP has a currently existing multi-format die (300) that can be used for the ganged print job (204, 506).

6. The print ordering system (606) of claim 4, wherein the memory (612) comprises code configured to direct the processor (608) to determine (410) that the individual label printing jobs (102-112) use a similar substrate.

7. The print ordering system (606) of claim 4, wherein the memory (612) comprises code configured to direct the processor (608) to determine (412) that the individual label printing jobs (102-112) are located in proximity to each other.

8. The print ordering system (606) of claim 4, wherein the memory (612) comprises code configured to direct the processor (608) to determine (410) that the individual label printing jobs (102-112) have similar lengths on a substrate.

9. The print ordering system (606) of claim 4, wherein the memory (612) comprises code configured to direct the processor (608) to place (418) an order for the ganged print job (204, 506) with the PSP (616, 618, 620).

10. A method (400) for optimizing a die cutting process, comprising:
identifying (404) individual label printing jobs (102-112) that are similar, wherein the individual label printing jobs (102-112) use different dies;
forming (414) a ganged print job (204, 506) from the individual label printing jobs (102-112), wherein the ganged print job (204, 506) uses a multi-format die (300); and
locating (416) a print service provider (PSP) (616, 618, 620) that can perform the ganged print job (204, 506).

11. The method of claim 10, wherein locating the PSP (616, 618, 620) comprises determining (416) whether a candidate PSP has a currently existing multi-format die (300) that can be used for the ganged print job (204, 506).

12. The method of claim 10, wherein locating the PSP (616, 618, 620) comprises determining (420) whether a candidate PSP (616, 618, 620) is willing to construct a multi-format die (300) for the ganged print job (204, 506).

13. A non-transitory, computer-readable medium (714), comprising code configured to direct a processor (702) to:
identify (408, 710) individual label printing jobs (102-112) that are similar, wherein the individual label printing jobs (102-112) use different dies; and
form (414, 710) a ganged print job (204, 506) from the individual label printing jobs (102-112), wherein the ganged print job (204, 506) uses a multi-format die (300).

14. The non-transitory, computer-readable medium (714) of claim 13, comprising code configured to direct the processor (702) to identify (416) whether a print service provider (PSP) (616, 618, 620) has the multi-format die (300) used for the ganged print job (204, 506).

15. The non-transitory, computer-readable medium (714) of claim 13, comprising code configured to direct the processor (702) to determine (420, 710) whether a multi-format die (200, 506) can be constructed for the ganged print job (204, 506).
